(19) United States
(12) Patent Application Publication
(10) Pub. No.: US 2005/0109977 A1
(43) Pub. Date: May 26, 2005

(54) Refrigerant composition

(75) Inventor: William Brown, Pleasantville, NY (US)

Correspondence Address: DOBRUSIN & THENNISCH PC, 29 W LAWRENCE ST, SUITE 210, PONTIAC, MI, 48342, US

(73) Assignee: Union Carbide Chemicals & Plastics Technology Corporation

(21) Appl. No.: 10/969,621

(22) Filed: Oct. 20, 2004

Related U.S. Application Data
(60) Provisional application No. 60/512,975, filed on Oct. 21, 2003.

(51) Int. Cl. F25D 1/00; C09K 5/00; C10M 101/00; F25B 43/02; F25B 1/00

(52) U.S. Cl. 252/68; 62/114

(57) ABSTRACT

This invention describes a new refrigerant/lubricant combination for use in stationary and mobile refrigeration and air conditioning applications. In these applications, the refrigerant and lubricant must be soluble in each other (e.g., miscible) to ensure adequate lubricant circulation from the compressor, through the condenser, expansion device, and evaporator, and back to the compressor. Insufficient lubricant circulation will result in compressor failure. Low temperature solubility is particularly important to ensure lubricant flow through the cold evaporator. In addition, the lubricant and refrigerant combination should be stable in the presence of steel, and aluminum and copper containing metals. This invention describes the combination of refrigerant difluoroethane (R-152a) and polar, oxygenated lubricants, particular polyalkylene glycols (PAGs) and polyolesters (POEs) which may be used as a ‘drop-in’ replacement for R-134a.

### CLAIM OF PRIORITY

This application claims the benefit of U.S. Provisional Application 60/512,975 filed on Oct. 21, 2003, incorporated herein by reference.

### FIELD OF THE INVENTION

This invention relates to an improved composition for use in devices that provide cooling or refrigeration.

### BACKGROUND OF THE INVENTION

In the late 1980's to early 1990's the refrigeration and air conditioning industries switched refrigerants from R-12 (CFC-12) to R-134a (HFC-134a) due to the later's zero ozone-depletion-potential. The mineral oil lubricants employed with R-12 were not soluble in R-134a. More polar lubricants were needed, and PAG and POE based lubricants were developed.

Because of concerns about global warming, efforts are being made to develop refrigerants that have lower global warming potential than R-134a, as well as zero ozone-depletion-potential. Indeed, R-134a cannot meet stringent newly proposed environmental standards related to global warming potential.

Much work is being done with CO₂ as a refrigerant, but the operating pressures of CO₂ refrigeration systems are 5 to 10 times higher that those experienced with R-134a. These high operating pressures pose both safety and mechanical reliability concerns. Indeed, use of CO₂ requires a complete redesign of refrigeration system in order to handle the elevated pressures. Thus, CO₂ is not a viable ‘drop-in’ replacement for R-134a; that is, current refrigeration system cannot use CO₂ as a refrigerant. The redesign expense makes CO₂ an unattractive alternative to R-134a.

Difluoroethane or R-152a is another alternative refrigerant. It has a zero ozone-depletion-potential and its global warming potential is much lower than that of R-134a, which makes it attractive. However, it has not previous been pursued as a replacement for R-134a because it is mildly flammable, whereas as R-134a is essentially inert. This obstacles have been significant enough to prevent the use of R-152a as a ‘drop-in’ replacement.

The inventors have recognized solutions to one or more of these problems.

### SUMMARY OF THE INVENTION

This invention describes a new refrigerant/lubricant combination for use in stationary and mobile refrigeration and air conditioning applications. In these applications, the refrigerant and lubricant must be soluble in each other (e.g., miscible) to ensure adequate lubricant circulation from the compressor, through the condenser, expansion device, and evaporator, and back to the compressor. Insufficient lubricant circulation will result in compressor failure. Low temperature solubility is particularly important to ensure lubricant flow through the cold evaporator. In addition, the lubricant and refrigerant combination should be stable in the presence of steel, and aluminum and copper containing metals. This invention describes the combination of refrigerant difluoroethane (R-152a) and polar, oxygenated lubricants, particular polyalkylene glycols (PAGs) and polyolesters (POEs) which may be used as a ‘drop-in’ replacement for R-134a.

### DETAILED DESCRIPTION

The present invention includes improved compositions, methods and systems for cooling and/or refrigeration. The compositions and methods may be used in stationary or mobile systems for producing cooling. For example, the compositions and methods may be used in air conditioning systems for commercial, industrial or residential buildings. The compositions and methods may also be used in refrigerators or freezers (stationary and mobile), whether commercial, industrial or residential. The present inventions find their preferred application in vehicle air conditioning systems and other portable cooling systems.

The invention includes circulating a composition that includes at least one refrigerant and at least one lubricant through a refrigeration device. The refrigeration device may include a compressor, a condenser and an evaporator, with a liquid refrigerant line containing an expansion device such as a capillary tube, orifice or thermal expansion valve between the condenser and evaporator. In operation, the compressor compresses the refrigerant vapors, which then condense to the liquid state in the condenser and pass through the liquid line and expansion device into the evaporator. The refrigerant vaporizes in the evaporator, thereby absorbing its latent heat of evaporation from the surrounding environment, which provides the cooling.

The refrigerant may be one or more hydrofluorocarbons, such as CH₃CHF₂, C₂HF₅, CH₂F₂, C₂H₃F₃, CHF₃ and C₂H₂F₄ which are commonly known as R-152a, R-125, R-32, R-143a, R-23 and R-134a, respectively. The preferred refrigerant is R-152a used alone, although it may be combined with other refrigerants to modify the refrigerant's overall properties, such as maintaining the boiling point or vapor pressure within a desired range. Hydrocarbons, such as propane and butane, may be used as secondary refrigerants that are used in combination with hydrofluorocarbon refrigerants.

The lubricant may be one or more polar, oxygenated compounds including polyalkylene oxides also known as polyalkylene glycols (PAGs), and polyol esters (POEs). Preferred PAG lubricants include methyl ether capped compounds, ester capped compounds and monols that have at least a single hydroxyl group. Diols and triols may also be suitable. The POE lubricants are esters of fatty acids with polyhydric alcohols, e.g. diols, triols and polyols, and/or polyhydric polyethers. The fatty acids include straight and branched fatty acids having from 2-20 carbon atoms and also polyacidic (e.g. diacid) fatty acids having from 4 to 36 carbon atoms. The polyol ester lubricants may be derived by esterifying, with one or more fatty acids, a polyhydric alcohol or a polyhydric polyether. The lubricants are selected to have a viscosity of between about 10 and about 460 cSt at 40° C., preferably between about 22 and about 220 cSt at 40° C. and most preferably between about 40 and about 150 cSt at 40° C.

The lubricant should have sufficient solubility in the refrigerant to insure that the lubricant can return to the compressor from the evaporator. Furthermore, the refrigerant and lubricant composition should have a low temperature viscosity so that the lubricant is able to pass through the cold evaporator. In one preferred embodiment, the refrigerant and the lubricant are miscible over a broad range of temperatures.

The portions of the refrigerant and lubricant in the composition are determined so that there is sufficient lubricant to lubricate the compressor. Typically, the lubricant makes up about 1 wt % to more than about 50 wt % of the composition at the time the composition is charged into a system; and preferably between about 5 wt % and about 30 wt %. The wt % of the lubricant will typically affect the mutual solubility of the refrigerant and lubricant and thus the available operating temperatures for the refrigeration device.

In another aspect of this invention, the solubility of the lubricant in the refrigerant is temperature dependent because the temperature within the compressor is usually significantly higher than the temperature within the evaporator. Preferably, in the compressor, the lubricant and the refrigerant are separate from each other and not soluble; the lubricant is a liquid and the refrigerant is a gas being compressed. On the contrary, in the evaporator, preferably the lubricant and the refrigerant are mutually soluble. This ideal situation would lead to minimal decreases in viscosity of the lubricant in the compressor due minimal dilution by the refrigerant. This in turn leads to better lubricity and decreased lubricant discharge from the compressor. At the same time, the low temperature solubility helps insure that any lubricant that is discharged from the compressor is returned by diluting the cold lubricant and thus keeping its viscosity low. Thus, in one embodiment, a lubricant that exhibits low temperature solubility and high temperature insolubility is desirable. In a preferred embodiment, the lubricant is soluble in the refrigerant at temperatures between about −40° C. and about 100° C., and more preferably in the range of about −40° C. and about 40° C. In another embodiment, attempting to maintain the lubricant in the compressor is not a priority and thus high temperature insolubility is not preferred. In this embodiment, the lubricant is soluble at temperatures above about 80° C., more preferably at temperatures above about 90° C., and most preferably at temperatures above about 100° C.

Several lubricants were investigated for suitability for use in combination with R-152a. The lubricants tested are summarized in Table 1 and include several PAG and POE lubricants as well as a mineral oil lubricant for comparison. The viscosity of the lubricant was also noted at 40° C.

TABLE 1
Description of Lubricants

| | | Lubricant | Lube |
|---|---|---|---|
| Lubricant (type) | Manufacturer | Chemistry | Viscosity (40° C.) |
| YN-9 (mineral | Idemitsu | Mineral Oil | 100 cSt |
| oil) | | (hydrocarbon) | |
| RL-488 (PAG) | Dow | PAG monol* | 135 cSt |
| RL-897 (PAG) | Dow | PAG monol* | 62 cSt |
| SP-10 (PAG) | Idemitsu | PAG methyl ether | 46 cSt |
| | | capped | |
| Retro 100 (POE) | Castrol | POE | 100 cSt |

*PAG monols have a single terminal hydroxyl group.

For each of the PAG lubricants, four compositions with R-152a were made, while two compositions each were made with the POE lubricant and the comparison mineral oil lubricant. Each of the compositions varied in the wt % of the lubricant in the composition where the composition contained only refrigerant and lubricant. The compositions were then tested at various temperatures or over a range of temperatures. The compositions were visually inspected to determine if, and at what temperature, the composition separated into its component parts. Other visual characteristics were also noted as appropriate.

TABLE 2
Solubility Temperature Range of Lubricants in R-152a

| Lubricant | 3 wt % | 10 wt % | 30 wt % | 50 wt %* |
|---|---|---|---|---|
| YN-9 | | Insoluble | | insoluble |
| RL-488 | <−40° C. to 58° C. | <−40° C. to 36° C. | <−40° C. to 39° C. | soluble at 22° C. |
| RL-897 | <−40° C. to 96° C. | <−40° C. to 89° C. | <−40° C. to 93° C. | soluble at 22° C. |
| SP-10 | <−40° C.** to 97° C. | <−40° C.** to 91° C. | <−40° C.** to 95° C. | soluble at 22° C. |
| Retro 100 | | <−40° C. to >100° C. | | soluble at 22° C. |

*The soluble temperature range for the 50% lubricant concentrations in R-152a were not determined.
**SP-10 dilutions were clear and colorless from room temperature (22° C.) to the high temperature cloud point. However, at −40 deg C the samples were hazy.

From the results of the testing, it can be seen that both the PAG and the POE lubricants exhibit excellent solubility in R-152a over a wide range of temperatures and weight percentages, whereas the mineral oil was never soluble in the refrigerant, regardless of the temperature or weight percentage. Also, RL-488 exhibited an advantageous temperature dependent solubility profile i.e. low temperature solubility and high temperature insolubility.

Likewise, the solubility of three PAG lubricants was tested for R-134a using the same procedure as described above substituting R-134a for R-152a. As mentioned above, four compositions with R-134a were made for each of the three tested PAG lubricants. Each of the compositions varied in the wt % of the lubricant. The compositions were then tested over a range of temperatures. The compositions were visually inspected to determine if, and at what temperature, the composition separated into its component parts. Other visual characteristics were also noted as appropriate.

TABLE 3
Solubility Temperature Range of Lubricants in R-134a

| Lubricant | 3 wt % | 5 wt % | 10 wt % | 20 wt % |
|---|---|---|---|---|
| RL-488 | <−40° C. to 41° C. | <−40° C. to 36° C. | <−40° C. to 33° C. | <−40° C. to 31° C. |
| RL-897 | <−40° C. to 68° C. | <−40° C. to 66° C. | <−40° C. to 57° C. | <−40° C. to 61° C. |
| SP-10 | <−40° C. to 75° C. | <−40° C. to 69° C. | <−40° C. to 65° C. | <−40° C. to 68° C. |

Testing the solubility of the lubricants in both R-152a and R-134a differs in that the upper temperature limit for R-134a is lower that for R-152a. The insolubility of R-134a at higher temperatures would create a composition that is not a single phase and this may interfere with the ability of the composition to be carried along through the condenser of a refrigeration system. A single phase composition in the condenser may be desirable for some systems .

Next, the long term stability of the refrigerant and lubricant compositions was studied. Mixtures of 50 wt % lubricant and 50 wt % R-152a were sealed in high pressure glass tubes along with steel, aluminum and copper containing metals. The tubes were then heated in an oven at 175° C. for 2 weeks. The compositions were visually inspected for the number of phases and cloudiness. Further, the metals were also visually inspected. The results are shown in Table 4. As can be seen, the refrigerant and lubricant remained soluble and stable over an extended period of time in the presence of metals likely to be found refrigeration systems.

TABLE 4
Stability of Lubricants in R-152a

| | Lubricant-R-152a | | | |
|---|---|---|---|---|
| Lubricant | Solution | Steel | Aluminum | Copper |
| YN-9 | clear, two phases | shiny | shiny | some tarnishing |
| RL-488 | clear, single phase | shiny | shiny | shiny |
| RL-897 | clear, single phase | shiny | shiny | shiny |
| SP-10 | hazy, single phase | shiny | shiny | shiny |
| Retro 100 | clear, single phase | shiny | shiny | slightly darkened |

Next, the lubricity of R-152a/lubricant compositions and R-134a/lubricant compositions were tested according to ASTM D3233 Modified Procedure A. The test procedure includes the use of a pin and V-block apparatus to incrementally increase the force of the V-block on the pin. For this test, samples of lubricant (95 ml) were saturated with either R-134a or R-152a. The lubricity, measured as load failure (lb.), was tested at about 24° C.

TABLE 5
Lubricity of R-152a and R-134a compositions

| | Load Failure for R-134a | Load Failure for R-152a |
|---|---|---|
| Lubricant | compositions | compositions |
| RL-488 | 2729 lb | 2321 lb |
| RL-897 | 1252 lb | 1190 lb |
| SP-10 | 1282 lb | 1287 lb |
| Retro 100 | 2924 lb | 780 lb |

The testing shows that R-152a compositions have similar lubricities as R-134a compositions, which means that it has good affinity for metal.

As seen above, R-152a/lubricant compositions possess desirable temperature solubility profiles and the compositions are stable. However, because of its cost and mild flammability, R-152a has not previously been a suitable substitute for R-134a. Because R-134a cannot meet the stringent environmental regulations related to global warming potential, R-152a/lubricant compositions, in spite of their drawbacks, are now a suitable substitutes for R-134a/lubricant compositions.

Further, R-152a/lubricant compositions are more desirable than using CO₂ because R-152a may be used as a ‘drop-in’ replacement for R-134a, whereas CO₂ cannot. Thus, the R-152a/lubricant compositions may be used to retrofit or recondition existing systems merely by replacing the existing refrigerant with the new composition. Furthermore, the cost of monitoring or controlling the mild flammability of R-152a is small in comparison to the cost of designing, manufacturing and using high pressure CO₂ systems .

The compositions of the present invention may also optionally include other additives such as lubricity additives or antiwear additives, such as those described in U.S. Pat. No. 5,152,926, which is hereby incorporated by reference.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A method for cooling, comprising:
circulating, in a refrigeration device, a composition comprising:
a refrigerant comprising difluoroethane; and
a lubricant comprising a polar, oxygenated lubricant,
wherein the lubricant is present in the composition in an amount of about 3 wt %, and
wherein the refrigerant and lubricant remain soluble at temperatures between less than about −40° C. and greater than about 45° C. for lubricants that have a viscosity of greater than about 75 cSt at 40° C. or wherein the refrigerant and lubricant remain soluble at temperatures between less than about −40° C. and greater than about 80° C. for lubricants that have a viscosity of between about 40 and about 75 cSt at 40° C.

2. The method of claim 1, wherein the circulating step comprises circulating the composition where the polar, oxygenated lubricant is selected from the group consisting of polyalkylene glycol (PAG), polyol ester (POE), and combinations thereof.

3. The method of claim 2, wherein the lubricant comprises a PAG monol, a methyl ether capped PAG or a POE.

4. The method of claim 1, wherein the composition remains stable for at least two weeks at an elevated temperature in the presence of at least one metal.

5. The method of claim 4, wherein the composition remains stable in the presence of steel, aluminum, copper, or combinations thereof.

6. The method of claim 1, wherein the composition further comprises an antiwear additive or a lubricity additive.

7. A refrigerant composition that may be utilized as a drop in replacement for refrigerants containing R-134a, comprising:
a refrigerant comprising difluoroethane; and
about 3 wt % of lubricant comprising a polar, oxygenated compound,
wherein the refrigerant and lubricant remain soluble at temperatures between less than about −40° C. and greater than about 45° C. for lubricants that have a viscosity of greater than about 75 cSt at 40° C. or wherein the refrigerant and lubricant remain soluble at temperatures between less than about −40° C. and greater than about 80° C. for lubricants that have a viscosity of between about 40 and about 75 cSt at 40° C.

8. The composition of claim 7, wherein the polar, oxygenated lubricant is selected from the group consisting of a PAG, a POE and combinations thereof.

9. The composition of claim 8, wherein the lubricant comprises a PAG monol, a methyl ether capped PAG or a POE.

10. The composition of claim 7, wherein the composition has a lubricity from about 750 lb. to about 2500 lb.

11. The composition of claim 7, wherein the composition remains stable for at least two weeks at an elevated temperature in the presence of at least one metal.

12. The composition of claim 11, wherein the composition remains stable in the presence of steel, aluminum, copper, or combinations thereof.

13. The composition of claim 7, wherein the refrigerant composition further comprises an antiwear additive or a lubricity additive.

14. An air conditioning system, comprising:
a compressor for compressing a reduced pressure vapor to an elevated pressure, elevated temperature vapor located in an automotive vehicle;
a condenser for removing heat from and condensing the elevated pressure, elevated temperature vapor to form an elevated pressure liquid;
an expansion device for reducing the pressure of the elevated pressure liquid to form a reduced pressure liquid;
an evaporator for evaporating the reduced pressure liquid to form the reduced pressure vapor; and
a refrigerant composition comprising difluoroethane and about 3 wt % of a polar, oxygenated lubricant wherein the difluoroethane and lubricant remain soluble at temperatures between less than about −40° C. and greater than about 45° C. for lubricants that have a viscosity of greater than about 75 cSt at 40° C. or wherein the refrigerant and lubricant remain soluble at temperatures between less than about −40° C. and greater than about 80° C. for lubricants that have a viscosity of between about 40 and about 75 cSt at 40° C.

15. The system of claim 14, wherein the polar, oxygenated lubricant is selected from the group consisting of a PAG, a POE and combinations thereof.

16. The system of claim 15, wherein the lubricant comprises a PAG monol, a methyl ether capped PAG or a POE.

17. The system of claim 14, wherein the composition remains stable for at least two weeks at an elevated temperature in the presence of at least one metal.

18. The system of claim 17, wherein the composition remains stable in the presence of steel, aluminum, copper, or combinations thereof.

19. The system of claim 14, wherein the composition further comprises an antiwear additive or a lubricity additive.
